(19) United States
(12) Patent Application Publication
(10) Pub. No.: US 2014/0114980 A1
(43) Pub. Date: Apr. 24, 2014

(54) Mining Developer Directories from Project Change History

(71) Applicant: INTERNATIONAL BUSINESS MACHINES CORPORATION, Armonk, NY (US)

(72) Inventors: Senthil Kumar Kumarasamy Mani, New Delhi (IN); Vibha Singhal Sinha, Indirapruam (IN)

(73) Assignee: INTERNATIONAL BUSINESS MACHINES CORPORATION, Armonk, NY (US)

(21) Appl. No.: 13/655,992

(22) Filed: Oct. 19, 2012

(51) Int. Cl. G06F 17/30

(52) U.S. Cl. 707/741; 707/E17.002

(57) ABSTRACT

Methods and arrangements for creating a searchable developer directory. A developer profile is generated relative to a project, the developer profile including information from change history with respect to the project. Metrics related to developer participation in the project are included in the developer profile, and the developer profile is indexed with at least one other developer profile to provide a search basis for search queries.

### BACKGROUND

Generally, in the context of IT (information technology) project work, multiple developers may be tasked with developing or working on new code. Generally, there is little done by way of keeping the skill and code ownership profile of the different developers both updated and visible, which could otherwise help in several respects. For instance, when someone new transitions into a project, he or she can quickly get an idea of who an “expert” in the project might be. When a developer moves out of a project, on the other hand, it might be good to know the type of KT (Knowledge Transition) that can be taken from him/her. Further, it can be helpful to identify the core developers of a project, and whom to contact to derive a better understanding of different aspects of the code. Also, at an organizational level, there is often a need to identify experts in an area, as well as find the best individuals to staff a project, based on a required skill set.

### BRIEF SUMMARY

In summary, one aspect of the invention provides a method comprising: generating a developer profile relative to a project, the developer profile including information from change history with respect to the project; including in the developer profile metrics related to developer participation in the project; and indexing the developer profile with at least one other developer profile to provide a search basis for search queries.

Another aspect of the invention provides an apparatus comprising: at least one processor; and a computer readable storage medium having computer readable program code embodied therewith and executable by the at least one processor, the computer readable program code comprising: computer readable program code configured to generate a developer profile relative to a project, the developer profile including information from change history with respect to the project; computer readable program code configured to include in the developer profile metrics related to developer participation in the project; and computer readable program code configured to index the developer profile with at least one other developer profile to provide a search basis for search queries.

An additional aspect of the invention provides a computer program product comprising: a computer readable storage medium having computer readable program code embodied therewith, the computer readable program code comprising: computer readable program code configured to generate a developer profile relative to a project, the developer profile including information from change history with respect to the project; computer readable program code configured to include in the developer profile metrics related to developer participation in the project; and computer readable program code configured to index the developer profile with at least one other developer profile to provide a search basis for search queries.

A further aspect of the invention provides a method comprising: generating a contributor profile relative to a project, the contributor profile including information from change history with respect to the project; including in the contributor profile metrics related to contributor participation in the project, the metrics including a classification of the contributor and a summary of files modified by the contributor; and indexing the contributor profile with at least one other contributor profile to provide a search basis for search queries.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 shows salient aspects of an entry in a developer directory.

FIG. 2 schematically illustrates a developer directory mining system.

FIG. 3 schematically illustrates a developer directory mining method.

FIG. 4 sets forth, by way of an illustrative example, information sets derived from change history as well as from an external source.

FIG. 5 sets forth illustrative examples of three different change set profiles.

FIG. 6 sets forth a process more generally for creating a searchable directory.

FIG. 7 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

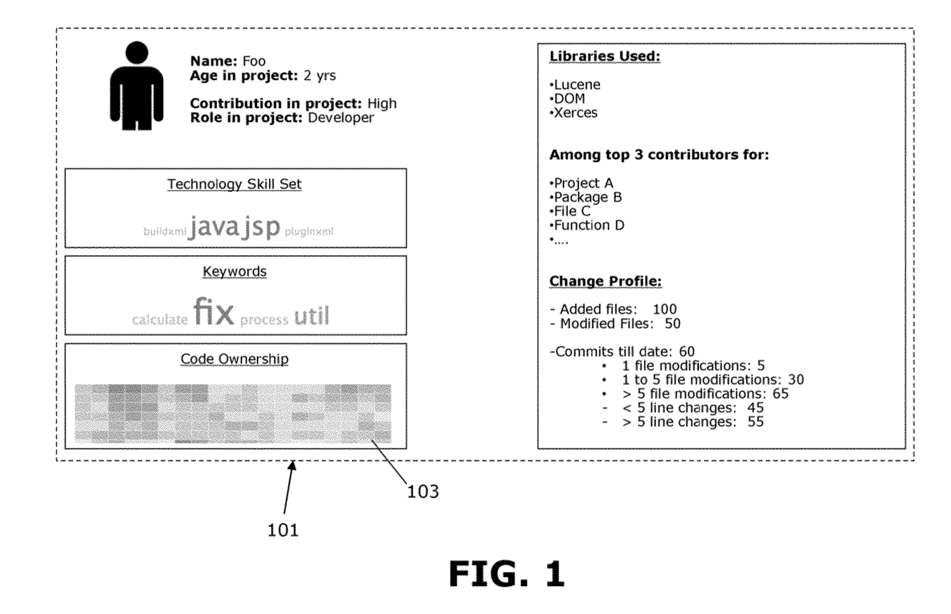

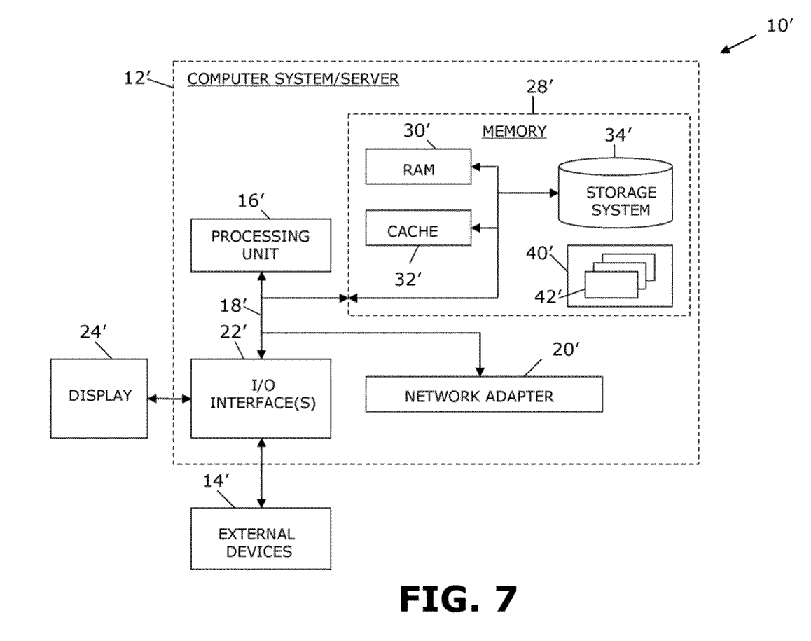

Specific reference will now be made herebelow to FIGS. 1-5. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 7. In accordance with an example embodiment, most if not all of the process steps, components and outputs discussed with respect to FIGS. 1-5 can be performed or utilized by way of a processing unit or units and system memory such as those indicated, respectively, at 16′ and 28′ in FIG. 7, whether on a server computer, a client computer, a node computer in a distributed network, or any combination thereof.

In accordance with at least one embodiment of the invention, there are broadly contemplated herein systems and methods for creating developer directories from project change history. As such, FIG. 1 shows salient aspects of an entry 101 in a developer directory. Here, various types of information are laid out such as a developer's name, age in the project, contribution and role in the project, technology skill set, searchable keywords and code ownership. In the code ownership section, each cell (in a heatmap representation 103 corresponding to a function, fn{developer commits, overall commits}) represents a package, and lighter coloring or shading represents “no commits”. (In this context, code ownership is determined by the amount of changes done by a particular developer to piece of code and such changes are represented [and defined] as “commits” to the code. For instance, if a developer is actively making changes to a set of code files with respect to the other developers, then it is more likely that he or she can be understood as having a greater share of ownership of the code files being modified with respect to other developers.) Also shown in the entry 101 is a list of libraries used by the developer, projects for which the developer was among the top three contributors, and a change profile. For searching purposes, the directory would be searchable on technology name, keywords, libraries, file, package, project name and nature of changes, where each search would return a ranked list of developers.

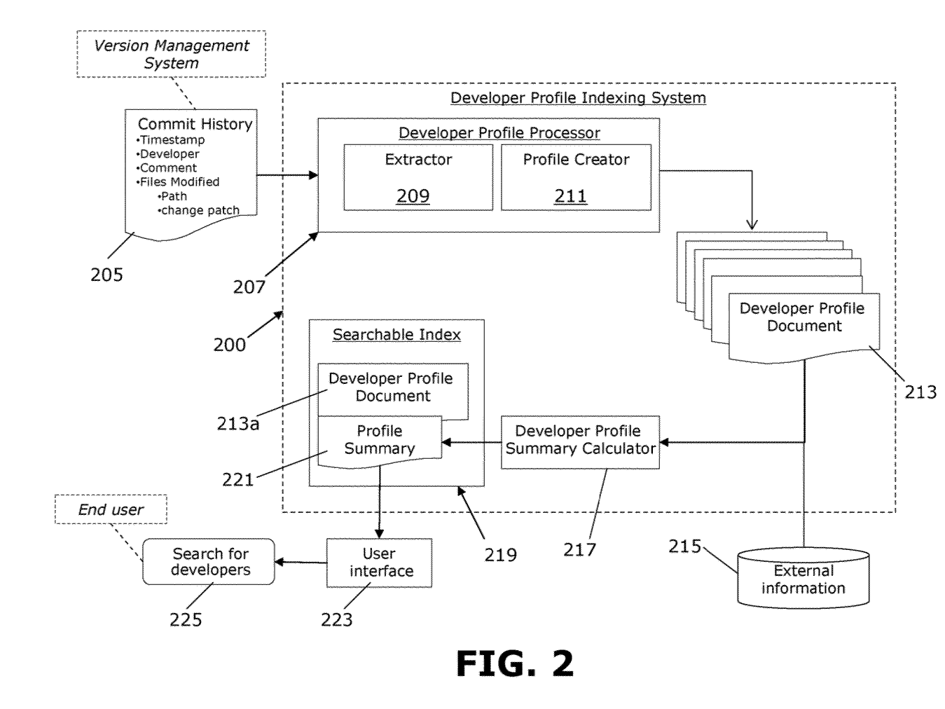

In accordance with at least one embodiment of the invention, as shown by way of an illustrative system 200 in FIG. 2, application (or project) change history 205 is extracted via an extractor 209 in a developer profile processor 207. This can be done periodically, or via regular polling, with respect to a change management server (or “version management system”), or (on the client side) whenever a developer commits to a project. The extracted change history contains information on: commit date, commit comment, committer, and per-file modified data on: file name, file path, change made. For instance, such information could contain (or be expressed as): “Foo, Jan. 5, 2012, Fixed XML Exception, Foo, com.ibm.research.XMLException, Added Line 10: Modified Line 20”.

In accordance with at least one embodiment of the invention, each change record is processed via a profile creator 211 to add information in the developer record. For each developer, one record is maintained among developer profile documents 213. The information added in developer record can include, for example:
Commit date, nature of commit (type of file, added or modified file), size of commit, files/package/project modified, dependencies added or external libraries used.
Commit comment and, if as part of commit, whether an in-code comment was modified/added
   Thereafter, external information 215 can be added to information from developer profile documents 213, wherein a profile summary calculator 217 yields, for a searchable index 219, a profile summary 221 that corresponds to an individual developer profile document 213a stored there. A developer directory is created with widgets to display: skill set, code ownership, keywords, change profile and libraries used.
   The searchable index can then be accessed by an end user to conduct a developer search (225) at a user interface 223.

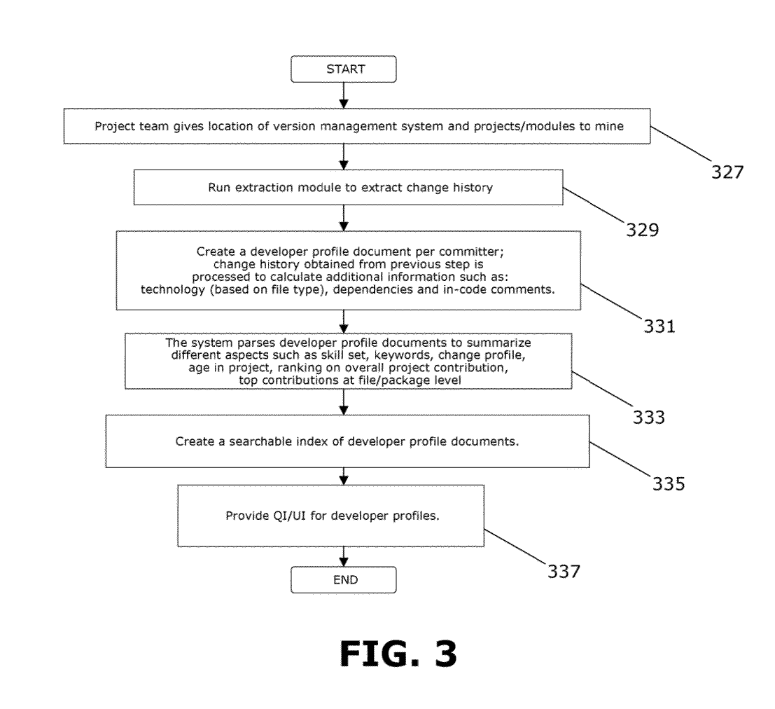

FIG. 3 schematically illustrates general method steps that can be performed by a system such as that shown in FIG. 2, in accordance with at least one embodiment of the invention. A project team can provide a location of a version management system and an indication of one or more projects or modules to mine for developers (327). An extraction module is run to extract change history (329), and one developer profile document per committer (contributing developer) is created (331), wherein the change history is processed to calculate additional information such as technology (based on file type), dependencies and in-code comments. Developer profile documents are then parsed to summarize different aspects such as skill set, keywords, change profile, age in project, ranking on overall project contribution and top contributions at a file or package level. (333). (In step 333, other metrics and summarization aspects can also be plugged in, as well as other parameters for calculating one or more metrics associated with a developer profile.) A searchable index is created of developer profile documents (335), and a query interface (QI) and/or user interface (UI) are provided to permit searching for developer profiles (337).

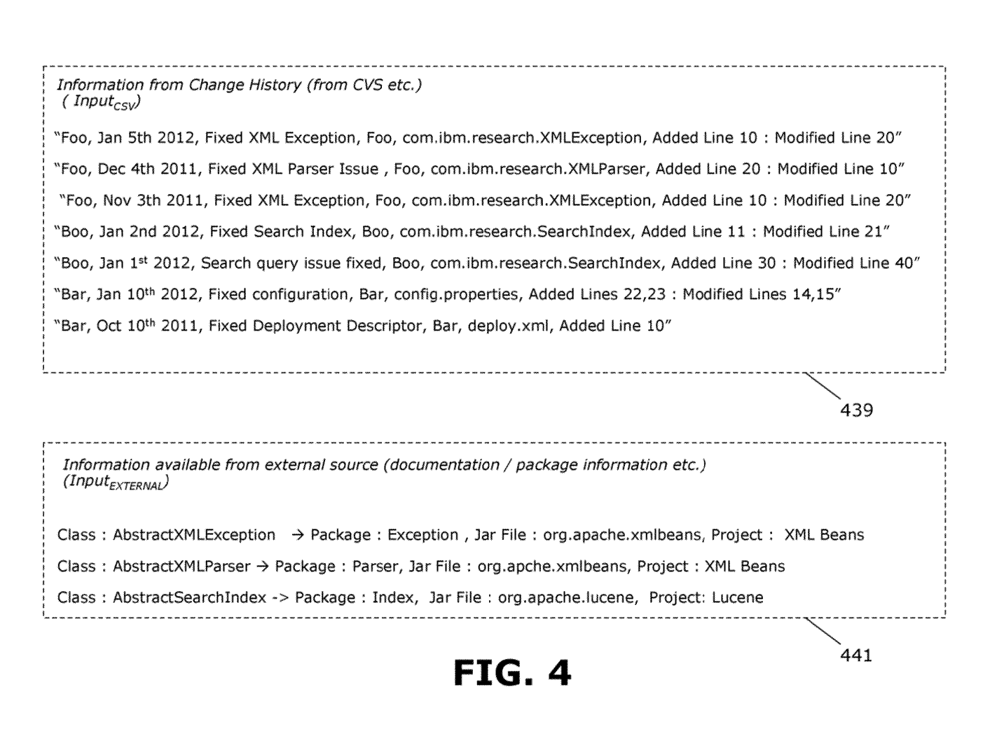

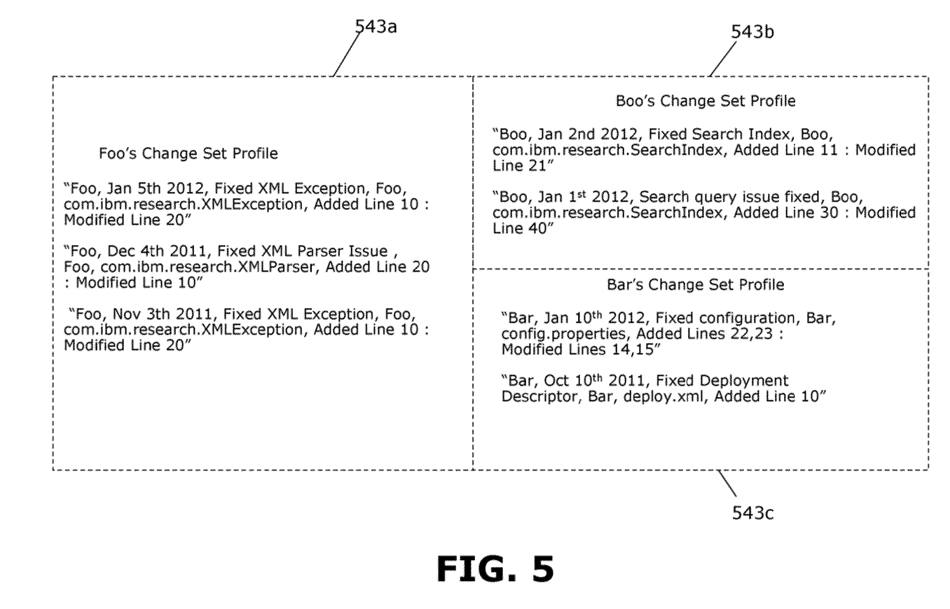

FIG. 4 sets forth, by way of an illustrative example according to at least one embodiment of the invention, information sets 439 and 441 derived, respectively, from change history (where “CVS” represents concurrent version systems used for maintaining source code versions) as well as from an external source (such as documentation, package information, etc.). A profile creator thus, for example, can use Input_{csv} and parse information therefrom to create a profile document per user. This document contains the list change activities performed by the user in the reverse chronological order, while any incremental activity performed by the user is included, as appropriate, in the respective user profile document. FIG. 5 sets forth illustrative examples of three different change set profiles (543a/b/c).

In accordance with at least one embodiment of the invention, a developer profile summarizer, for each user, employs the information present in the profile document and any external input available (Input_{EXTERNAL}) to infer the following information about the user: age, role and heat map. Age of a user is calculated in terms of the time period during which the first and last commits were done towards the project by the user. For instance, relative to the example of FIGS. 4 and 5, the users' ages are: Foo—2 mo.; Boo—2 days; Bar—3 mo.

In accordance with at least one embodiment of the invention, role of the user is determined, for each file modified by the user in the change set , by associating a file type as “Source” or “Non-source” (and possibly also “Test” as a sub-type within “Source”) By way of illustrative example, files ending with “.java, .c” etc., can be considered to be Source files, while files ending with .xml , .properties, etc., can be considered to be Non-source files. If the user has typically modified source files, he or she can be assigned a “Developer” role. If non-source files are typically modified by the user, then a role such as “Build / Deployment Specialist” might be an appropriate role. If Test related files are typically modified by a user, then the user can be considered to be a “Tester”. Thus, relative to the example of FIGS. 4 and 5, the roles can be: Foo—Developer; Boo—Developer; and Bar-Build/Development Specialist.

In accordance with at least one embodiment of the invention, guidelines or thresholds for delineating or determining “Developer”, “Build/Deployment Specialist” and “Tester” roles, among other possible roles, can be selected and/or applied in any manner deemed suitable. Accordingly, as an illustrative example, if a user has modified only source files, then he/she can be assigned a Developer role. If again, the user has modified a considerable amount of source files when compared to non-source files (e.g., 80% Source and 20% Non-source), then he/she can be assigned a developer role. If the user has modified only Source files which are associated with testing then he/she can be assigned a role of a “Tester”. Other guidelines and/or thresholds can be developed and applied as deemed appropriate for the application at hand.

In accordance with at least one embodiment of the invention, a heatmap (e.g., such as the one shown in FIG. 1 at 103) can be generated based on the commits done to the files by the user. Thus, there is created a hierarchical summary of the number of files modified per user, which can be expressed as, e.g.: package⋄component⋄project. Using tree map visualization, these data can be viewed at all three levels using a feature of drill-down.

In accordance with at least one embodiment of the invention, a skill set of a user can be derived using commit comments associated with commits done by the user and performing topic mining from these comments to yield a set of keywords. Using an external input corresponding to one or more skills, and matching these with keywords, the collection of keywords identified can be mapped to a corresponding skill for the user. (Thus, the external input already generally matches the keywords. For instance, for external input indicating “Search”, corresponding keywords can include “Search, Query, Index”, while for external input of “XML” the keywords can include “Parser, Exception”. Thus, by matching keywords mined from user comments, one can map such keywords to the external “skill” input and thereby identify core skills.) For example, relative to the example of FIGS. 4 and 5, Foo's keywords from commit comments can be “XML, Parser, Exception,” hence a primary skill can be indicated as XML, while Boos' keywords from commit comments can be “Search, Query, Index,” hence a primary skill can be indicated as SEARCH.

In accordance with at least one embodiment of the invention, external packages used by the user in development can be derived via using external data such as API documentation and comparing such data with “imports” used by the source files and “definition/use pairs” modified by the user. Thus, external packages corresponding to each user can be listed. For instance, relative to the example of FIGS. 4 and 5, information here can include Foo having modified XMLParser and XMLException and, from the lines modified, had used “AbstractXMLParser” and “AbstractXMLException”. From the external data of API documentation and import statements used on the files (“import org.apache.xmlbeans.AbstractXMLParser”), it is then known that these classes map to “XML Beans Project.” Similarly for Boo, it can be identified that the external package being used is Lucene.

In accordance with at least one embodiment of the invention, summarized developer profile information, or metrics, are indexed for searching. Each developer profile is shown through a User interface profile page highlighting the various aspects of the profile summary, e.g.: Age, Role, Skill Set, heat map of contribution, external packages used etc. Navigation options provided to the end-users viewing the profiles can be as follows. In navigation based on similarity of profiles, a user can choose this option to view other profiles which are similar to the profile they are currently viewing, e.g., based on similarity with respect to Age, Role, Skill set, etc. In search-based navigation, users can perform free text search. Here, the text (i.e., query entered) is searched against the various facets that have been indexed (e.g., Age, Role, Skill Set, External Library, Package Name, Component Name, Project Name, etc.). A ranked set of developer profiles matching the search query are returned, which can be further navigated in detail. In a faceted query search, complex logic-based queries can also be executed across facets. For instance, specifications can be made such as “Role is ‘Developer’ and Age>‘4 years’”.

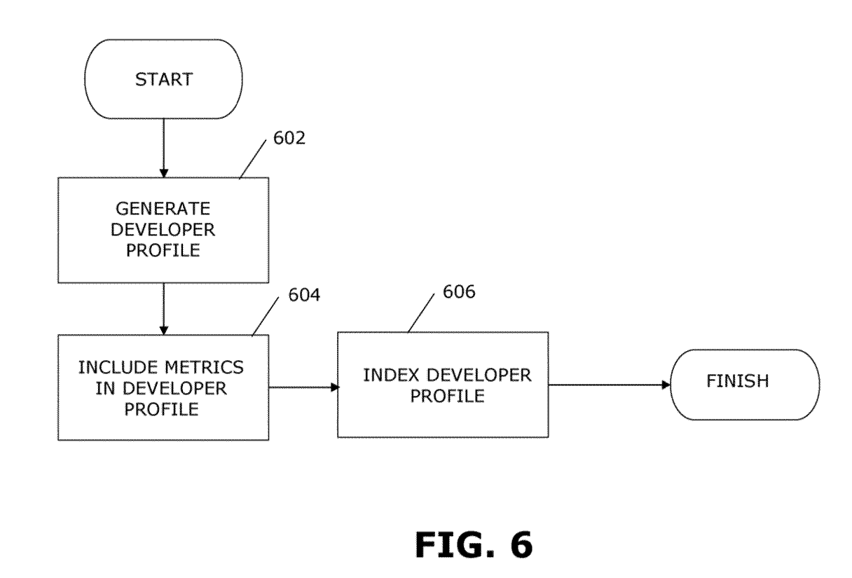

FIG. 6 sets forth a process more generally for creating a searchable directory, in accordance with at least one embodiment of the invention. It should be appreciated that a process such as that broadly illustrated in FIG. 6 can be carried out on essentially any suitable computer system or set of computer systems, which may, by way of an illustrative and non-restrictive example, include a system such as that indicated at 12′ in FIG. 7. In accordance with an example embodiment, most if not all of the process steps discussed with respect to FIG. 6 can be performed by way of a processing unit or units and system memory such as those indicated, respectively, at 16′ and 28′ in FIG. 7.

As shown in FIG. 6, a developer profile is generated relative to a project, the developer profile including information from change history with respect to the project (602). Metrics related to developer participation in the project are included in the developer profile (604), and the developer profile is indexed with at least one other developer profile to provide a search basis for search queries (606).

Referring now to FIG. 7, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
generating a developer profile relative to a project, the developer profile including information from change history with respect to the project;
including in the developer profile metrics related to developer participation in the project; and
indexing the developer profile with at least one other developer profile to provide a search basis for search queries.

2. The method according to claim 1, wherein said generating comprises including information relative to the project from an external source.

3. The method according to claim 1, wherein said generating comprises employing a list comprising at least one commit associated with the developer.

4. The method according to claim 1, wherein the metrics comprise at least one member selected from the group consisting of: age of the developer in the project; role of the developer in the project; a summary of files modified by the developer; at least one skill of the developer; and at least one external package employed by the developer in the project.

5. The method according to claim 4, wherein the summary of files is conveyed as a heatmap.

6. The method according to claim 5, wherein the heatmap presents variable patterning as a function of developer commits to at least one file.

7. The method according to claim 4, wherein said indexing comprises including at least one searchable keyword in the developer profile.

8. The method according to claim 7, wherein the at least one searchable keyword is mappable to the at least one skill of the developer.

9. The method according to claim 4, wherein the role of the developer comprises one of: a developer role; and a tester role.

10. The method according to claim 4, wherein the role of the developer is determined on the basis of a file type of at least one file modified by the developer.

11. An apparatus comprising:
at least one processor; and
a computer readable storage medium having computer readable program code embodied therewith and executable by the at least one processor, the computer readable program code comprising:
computer readable program code configured to generate a developer profile relative to an project, the developer profile including information from change history with respect to the project;
computer readable program code configured to include in the developer profile metrics related to developer participation in the project; and
computer readable program code configured to index the developer profile with at least one other developer profile to provide a search basis for search queries.

12. A computer program product comprising:
a computer readable storage medium having computer readable program code embodied therewith, the computer readable program code comprising:
computer readable program code configured to generate a developer profile relative to a project, the developer profile including information from change history with respect to the project;
computer readable program code configured to include in the developer profile metrics related to developer participation in the project; and
computer readable program code configured to index the developer profile with at least one other developer profile to provide a search basis for search queries.

13. The computer program product according to claim 12, wherein said computer readable program code is configured to include in the developer profile information relative to the project from an external source.

14. The computer program product according to claim 12, wherein said computer readable program code is configured to generate the developer profile via employing a list comprising at least one commit associated with the developer.

15. The computer program product according to claim 12, wherein the metrics comprise at least one member selected from the group consisting of: age of the developer in the project; role of the developer in the project; a summary of files modified by the developer; at least one skill of the developer; and at least one external package employed by the developer in the project.

16. The computer program product according to claim 15, wherein the summary of files is conveyed as a heatmap.

17. The computer program product according to claim 16, wherein the heatmap presents variable patterning as a function of developer commits to at least one file.

18. The computer program product according to claim 15, wherein said computer readable program code is configured to include at least one searchable keyword in the developer profile.

19. The computer program product according to claim 18, wherein the at least one searchable keyword is mappable to the at least one skill of the developer.

20. The computer program product according to claim 15, wherein the role of the developer is determined on the basis of a file type of at least one file modified by the developer.

21. A method comprising:
generating a contributor profile relative to a project, the contributor profile including information from change history with respect to the project;
including in the contributor profile metrics related to contributor participation in the project, the metrics including a classification of the contributor and a summary of files modified by the contributor; and
indexing the contributor profile with at least one other contributor profile to provide a search basis for search queries.
